(19) United States
(12) Patent Application Publication
(10) Pub. No.: US 2007/0181603 A1
(43) Pub. Date: Aug. 9, 2007

(54) Dispensing closure for containers

(75) Inventors: Filip Dominique Hubert Vangeel, Vilvoorde (BE); Alex James Orchard, Brussels (BE)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Proctor & Gamble Company

(21) Appl. No.: 11/703,929

(22) Filed: Feb. 8, 2007

(30) Foreign Application Priority Data
Feb. 6, 2006 (EP) 06101318.1

(51) Int. Cl. B67D 5/06; B67D 3/00

(52) U.S. Cl. 222/182; 222/520; 222/525

(57) ABSTRACT

The present invention relates to a closure suitable for dispensing pourable product from a container. More specifically, the present invention is directed to a “twist to open” type closure operated by a twisting action.

### TECHNICAL FIELD

The present invention relates to a closure suitable for dispensing pourable product from a container. More specifically, the present invention is directed to a “twist to open” type closure operated by a twisting action.

### BACKGROUND OF THE INVENTION

Dispensing closures for containers are commonly known in the art and may be based on various opening mechanisms such as “push and turn”, “twist and turn”, “twist to open” or “push and pull”. Those closures are commonly used in combination with containers designed to contain products such as food, beverages, personal care products, pharmaceutical or cosmetic products. Typical types of dispensing closures are for example described in U.S. Pat. No. B1-6,202,876 (push and twist), U.S. Pat. No. 5,305,932 (snap-on), US-A-2004015507 (push and pull) or in WO 2004/110889 (push to open). The specific type of “twist to open” closures is described for example in U.S. Pat. No. B1-5,305,932; EP-B1-0 378 488; WO 00/30949; EP-A1-0 417 891 and in WO 03/050033.

Although the above-types of closures will generally function satisfactorily in the applications for which they are designed, they typically only permit slow dispensing of limited amount of fluids. However, in certain circumstances, it is required to dispense the contained products much faster and in a relatively large quantity. This is typically the case in the context of liquid detergent containers. It has indeed been discovered that the users of containers equipped with the corresponding dispensing closures primarily seek for the fastest possible delivery of the contained liquid detergent into an appliance or receptacle. Most commonly used closures for containers adapted for delivering liquid detergent compositions, which are typically viscous liquids by nature, are described e.g. in EP-B1-0 109 704. Those dispensing closures typically consist of two separate parts: a spouted transition piece and a screw-type cap. Although the spouted piece allows for precise pouring of the viscous liquid into the intended receptacle, the cap is however often seen as difficult and/or too long to open and may easily get lost.

Another drawback associated with the use of the above dispensing system is that under usage, liquid detergent compositions may be spilled in the area where liquid detergent is consumed and/or on the user's hands which may lead to skin irritation or even burns. This often occurs when the above-mentioned cap is also used as a dosing means.

It is therefore an objective of the present invention to provide a dispensing closure suitable for dispensing pourable product from a container which provides fast dispensing of the contained product and which overcomes the above-mentioned drawbacks.

It has now been found that the above objective can be met by providing a dispensing closure according to the present invention.

Advantageously, the dispensing closure according to the present invention exhibits improved opening/closing ergonomics. A further advantage associated with the dispensing closure according to the present invention is that it provides excellent sealing vis-à-vis the contained product. Also, the dispensing closure according to the present invention is easy-to-use while reducing risk of product spillage.

It is still another advantage that, due its particular configuration, the dispensing closure of the present invention provides more convenient way of dispensing pourable product and allows better viewing of the amount of product being dispensed.

It is still a further advantage that the dispensing closure of the present invention provides a more aesthetic appeal when compared to similar closures known in the art, and contributes to provide the user with a more pleasant experience while operating domestic tasks.

Advantageously, the dispensing closure according to the present invention does not require any modification of the container on which it is mounted, for the dispensing closure to become operable.

Other advantages and more specific properties of the dispensing closure according to the present invention will be clear after reading the following description of the invention in combination with the attached drawings.

### SUMMARY OF THE INVENTION

The present invention relates to a dispensing closure suitable for being mounted on a container, the container having a dispensing opening and being suitable for containing a pourable product in its interior volume, wherein the dispensing closure comprises:
(a) a base member comprising a means for attachment to the container, a hollow sleeve defining a draining canal adapted to communicate with the interior volume of the container, and wherein the hollow sleeve comprises an obstructing member;
(b) a discharging means adapted to communicate with the draining canal via a dispensing passage capable of dispensing the pourable product;
(c) an actuating means which under actuation is capable of actuating primary complementary means of raising and lowering said discharging means, wherein said primary complementary means are located in said discharging means and in said hollow sleeve, and are adapted to switch said discharging means from a lower position wherein said dispensing passage is sealingly obstructed by said obstructing member with respect to the content of said container, and an upper position wherein said dispensing passage is unobstructed; and wherein said primary complementary means are actuated by secondary complementary means of raising and lowering said discharging means which are located in said actuating means and in said discharging means.

In another embodiment, the present invention is directed to a container closure assembly, comprising:
(a) a container having a body portion for holding container content, a lower closed end for supporting the container, an upper end including a means of attachment thereon adapted to receive and affix a dispensing closure for containers; and
(b) a dispensing closure as above-indicated, mounted on the container.

The present invention further encompasses a method of dispensing the content of a container comprising the steps of:
(a) providing a container closure assembly as above-described wherein the discharging means is in its lower position;
(b) actuating the actuating means so as to raise the discharging means to its upper position;
(c) pouring the required amount of the container content through the dispensing passage;
(d) actuating the actuating means so as to lower the discharging means back towards its lower position.

### BRIEF DESCRIPTION OF THE DRAWINGS

FIG. 1 is a cross-section view of a container closure assembly according to the present invention. The assembly comprising a container into which is mounted a dispensing closure according to another embodiment of the invention.

FIG. 2 is a top perspective view of a dispensing closure according to the invention in its lower/closed position.

FIG. 3 is a side view of a dispensing closure according to the invention in its lower/closed position.

FIG. 4 is a top perspective view of a dispensing closure according to the invention in its upper/open position.

FIG. 5 is a side view of a dispensing closure according to the invention in its upper/open position.

FIG. 6 is an exploded side view of a dispensing closure according to the invention, which shows the base member, the discharging means and the actuating means separately.

FIG. 7 is an exploded perspective view of a dispensing closure according to the invention.

FIG. 8 is a top view of a dispensing closure according to the invention in its lower/closed position.

FIG. 9 is a cross-sectional side view along plan (B-B) of the dispensing closure of FIG. 8.

FIG. 10 is a top view of a dispensing closure according to the invention in its upper/open position.

FIG. 11 is a cross-sectional side view along plan (C-C) of the dispensing closure of FIG. 10.

### DETAILED DESCRIPTION OF THE INVENTION

For the purposes of promoting and understanding the principles of the present invention, reference will be made to the embodiment illustrated in the drawings and specific language will be used to describe the same. While this invention is susceptible of embodiments in many different forms, this specification and the accompanying drawings discloses specific forms as examples of the invention. However, the invention is not intended to be limited to the embodiment so described.

In a first embodiment, the present invention is directed to a dispensing closure suitable for being mounted onto a container having a dispensing opening.

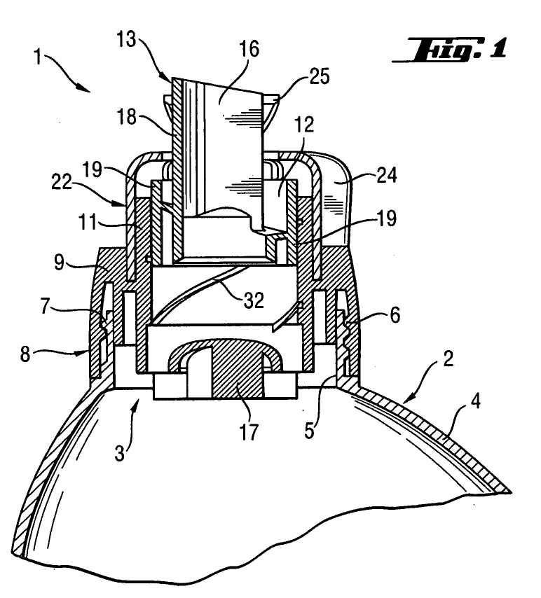

### Referring now to FIG. 1, a dispensing closure according to a first embodiment of the invention is represented which is mounted onto a container.

### Container 2

In a preferred embodiment, the container comprises a body portion for holding container content, a lower closed end for supporting said container, an upper end including a neck delimiting a dispensing opening. The dispensing closure of the present invention may be securely mounted onto said container, via its base member, using any means of attachment commonly know to those skilled in the art including cooperative threads, crimping, clipping means, heat sealing force fitting, clasp elements, snap-fit bead, groove arrangements, and mixtures thereof.

Preferably, the dispensing closure of the invention is provided with an inner female thread typically located in the base member, as described hereinafter, and the container neck is preferably provided with a complementary male thread formed adjacent its dispensing opening, although other complementary attachment means may also be envisaged. Typically, the dispensing closure is mounted onto the container with the female thread of the base member screwed on the male thread of the container.

Alternatively, the container may not need to have a neck. Instead the container may consist of a just a body portion with a dispensing opening. The dispensing closure of the present invention is suitable for use with a variety of conventional or special containers having various designs, the details of which, although not illustrated or described, would be apparent to those skilled in the art. The container may have a rigid wall or walls, or may have a somewhat flexible wall or walls.

In a preferred aspect of the invention, the dispensing closure is a separate element which is adapted to be removably or non-removably mounted, via its base member, to a previously manufactured container which has a dispensing opening to the container interior. In an alternative execution, the dispensing closure may be formed as a unitary part, or extension, of the container. The dispensing closure is adapted to be used with a container having a dispensing opening to provide access to the container interior volume and to a product contained therein, which is preferably a pourable product. However, the dispensing closure of the invention may be used with many products, including but not limited to, relatively low or high viscosity liquids, creams, gels, suspensions, mixtures, lotions, pastes, particulates, granular products, and mixtures thereof. Typical products for use in the present invention may be those constituting a food product, a personal care product, an industrial or household cleaning product, or other compositions of matter for use in activities involving manufacturing, commercial or household maintenance, construction, agriculture.

Preferably, said pourable product is a liquid composition, more preferably a viscous liquid composition, most preferably a laundry liquid detergent composition.

### Base Member 8

The dispensing closure according to the present invention comprises as a first essential element, a base member. FIG. 6 shows is a side view of the base member for use in the dispensing closure according to the invention.

The base member is intended to be mounted onto a container using any suitable means of attachment as indicated above. Suitable means of attachment are designed so as to provide secure sealing between the dispensing closure and the container vis-à-vis its content.

The base member may have any suitable configuration, form or dimension for accommodating an upwardly projecting neck or portion of a container. A preferred execution of the present invention, wherein the base member has a substantially circular shape, when seen from the top, is represented in the accompanying drawings.

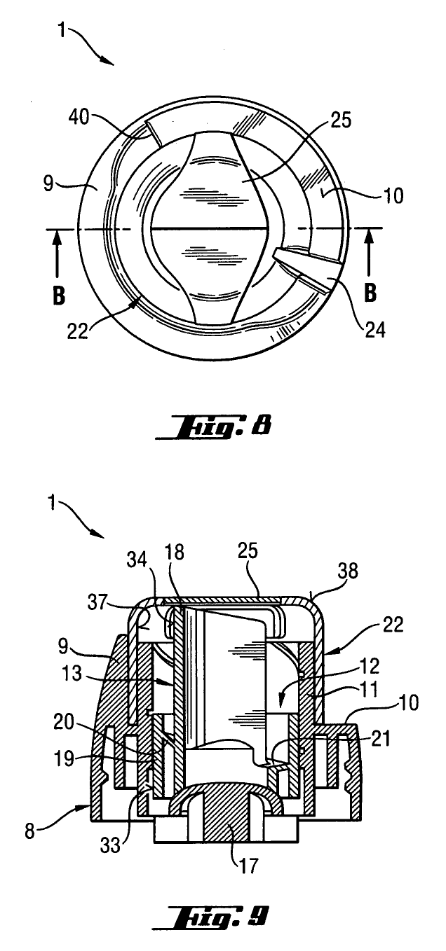

The base member is preferably comprised of two distinct parts: a skirt and a platform. The skirt generally forms the external envelope of the base member and extends substantially towards the container direction, typically parallel to the neck of the container. Preferably, the skirt has a substantially cylindrical shape, preferably a cylindrical shape. The platform typically extends substantially transversely to the longitudinal axis of the container. In a preferred execution of the present invention, the platform has a substantially flat, plate-like shape and is substantially horizontal. As shown in FIG. 9 and FIG. 11, the means for attachment is preferably located onto the inner wall of the skirt.

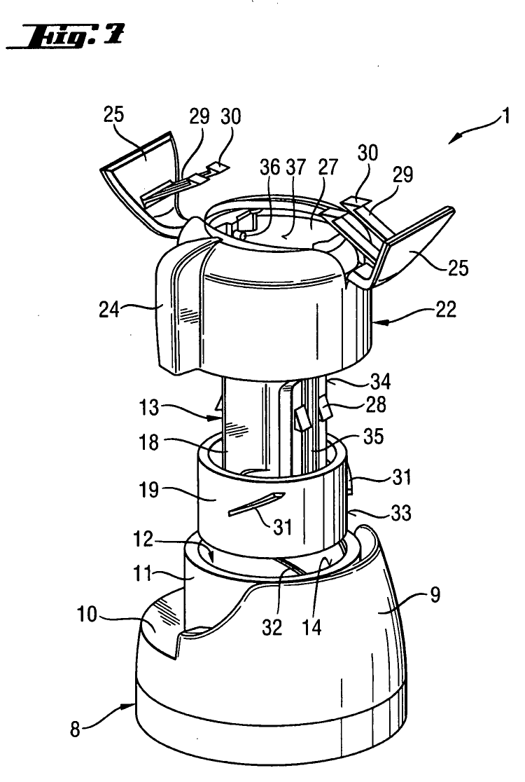

Referring now specifically to FIG. 6 and FIG. 7, the base member further comprises a hollow sleeve defining a draining canal adapted to communicate with the interior volume of the container such as to permit dispensing of the container content by the discharging means, via the dispensing opening and the dispensing passage, as described below.

The hollow sleeve is adapted so as engage the hereafter-described discharging means preferably for axial motion with respect to said hollow sleeve. Suitable hollow sleeve for use herein will be readily apparent to those skilled in the art. However, in a preferred execution, the hollow sleeve has a substantially cylindrical shape, preferably a cylindrical shape, and is provided with an inner and an outer surface. Said draining canal is typically delimited by the inner surface of said hollow sleeve.

Preferably, the hollow sleeve extends upwardly and downwardly from said platform, and is open at both ends. The hollow sleeve which is preferably located in a central position vis-à-vis the base member, may preferably extend substantially towards the container direction, typically parallel to the neck of the container and therefore towards a substantially vertical axis.

As specifically shown in FIG. 9 and FIG. 11, the base member further comprises an obstructing member, the role of which is to occlude the hereinafter-described dispensing passage in a tight manner vis-à-vis the content of the container when said discharging means is in its lower position.

The obstructing member for use herein may have any suitable configuration, form or dimension for accommodating said hollow sleeve and said dispensing passage. Suitable obstructing member for use herein will easily be recognized by those skilled in the art. In a preferred execution, the obstructing member has a substantially rounded, convex shape with the convexity turned towards the discharging means. According to this preferred execution, the discharging means is provided with a correspondingly concave portion adapted so as to allow proper obstruction of said dispensing passage and providing an efficient liquid tight seal. According to a highly preferred execution of the present invention, said obstructing member has a substantially mushroom-like shape, preferably a mushroom-like shape.

In a highly preferred execution of the present invention, said obstructing member is present in the lower part of said hollow sleeve and is preferably located in a central position with respect to the draining canal delimited by said hollow sleeve. Said obstructing member being an integral part of said hollow sleeve, it is typically connected to the inner surface of said hollow sleeve by means of connecting rays (not represented) which are adapted to allow the content of said container to pass through the apertures formed between said connecting rays around said obstructing member.

The constituting parts of the base member are formed from any suitable material commonly known in the art. Preferably, said parts are all formed from heat sealable thermoplastic materials such as polyethylene or polypropylene single piece. Accordingly, and in a preferred execution of the invention, the base member is a monolithic piece formed from the same thermoplastic material. According to this specific embodiment, the different parts may be advantageously molded within a single injection molding operation which therefore involves both a simple and economical manufacturing process.

### Discharging Means 13

The dispensing closure according to the present invention comprises, as a further element, a discharging means. FIG. 6 shows is a side view of a dispensing means suitable for use in the present invention.

Discharging means for use herein may be readily recognized and selected by those skilled in the art provided said discharging means is adapted so as to be engaged by said hollow sleeve, preferably for axial motion with respect to said hollow sleeve. Preferably, said discharging means is a pouring spout. In a more preferred execution, the discharging means is a beveled spout comprising a spout stem and a spout barrel. Such preferred spout allows better control and more precise dispensing of the container content, especially viscous liquids such as liquid detergents. It is preferred that said spout stem and said spout barrel have a substantially cylindrical shape, wherein the diameter of said spout barrel is preferably greater than that of said spout stem, but slightly inferior to the that of said hollow sleeve. Accordingly, said spout barrel is preferably located within said hollow sleeve.

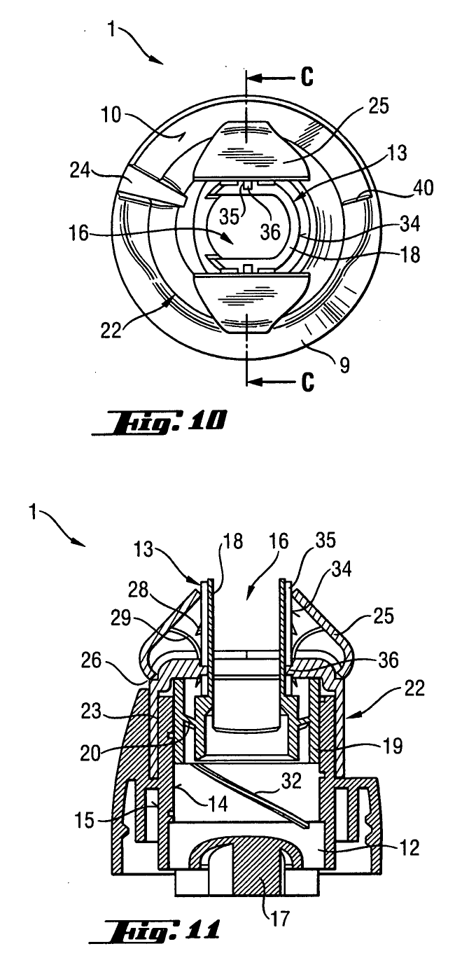

As shown in FIG. 9 and FIG. 10, said spout stem is typically, connected to said spout barrel via a connecting ring. In a highly preferred embodiment of the present invention, said connecting ring is provided with apertures communicating with the interior of the container so as to permit the recuperated product to be drained back into the container. Additionally, said apertures will also constitute air intake means adapted to allow air to penetrate into the container in response to the evacuation of its content and thereby contribute to a better dispensing of the container content, preferably viscous liquids.

The discharging means for use in the present invention may be formed from any suitable material commonly known in the art. Preferably, said discharging means is formed as a single piece from heat sealable thermoplastic materials such as polyethylene or polypropylene single piece.

### Actuating Means 22

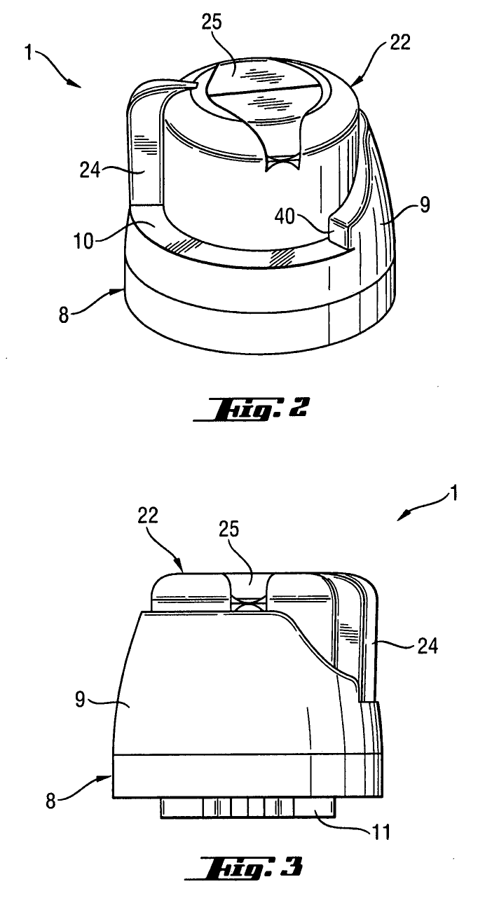

The dispensing closure according to the present invention further comprises an actuating means, which under actuation is capable of actuating the hereinafter-described secondary complementary means of raising and lowering said discharging means. FIG. 6 shows a side view of said actuating means, whereas FIG. 2 represents a top perspective view thereof.

Preferably said actuating means is a separate piece from said base member and from said discharging means. The actuating means may have any suitable configuration, form or dimension provided it is suited for performing the purported action. As will be easily appreciated by those skilled in the art, multiple configurations may be suitably used for such an actuating means.

The actuating means is, when actuated, capable of activating said secondary complementary means thereby causing said discharging means to be raised or lowered preferably within said hollow sleeve.

According to a preferred embodiment of the present invention, said actuating means is a turning cap, as represented in the accompanying drawings. Said turning cap may be of any shape commonly known in the art, including but not limited to circular, square, rectangular, ovoid or triangular.

The actuating means may be located at any suitable position provided it is easily accessible by the user's fingers. Such suitable positions may be readily identifiable by the person skilled in the art. More preferably, said turning cap has a substantially cylindrical shape, preferably cylindrical shape. According to this preferred execution, said turning cap is typically located such as to cover and mask, at least partially, said discharging means when the latter is its lower position. Preferably, said turning cap is provided with a centrally positioned opening intended to permit said discharging means to traverse and emerge through said turning cap when said discharging means is in its upper position. Accordingly and in a highly preferred execution, said turning cap has a diameter which is slightly superior to that of said hollow sleeve so as for it to properly cover said hollow sleeve, as well.

In a preferred execution, said actuating means extends upwardly from said platform and at least part thereof advantageously projects out from the skirt via a housing created into the skirt for that purpose. This preferred execution allows achieving improved opening/closing ergonomics. Typically, said actuating means is capable of rotatably translating onto the plan formed by said platform, and is preferably operated by using one finger during the dispensing operation. According to this very preferred execution, the actuation of said actuating means operated by rotation thereof.

The actuating means for use herein is typically provided with an inner surface and an outer surface. According to a preferred aspect of the invention, said outer surface of said actuating means is further provided with a gripping means, which is preferably a finger grip and which is typically located onto said at least part of the actuating means which projects out from the skirt. Any gripping means commonly known in the art may be used in the context of the present invention. In a very preferred embodiment, the gripping means is especially adapted to provide suitable gripping by pinching with two fingers.

The exterior configuration of the actuating means for use herein may be varied as desired for aesthetic appearance or for further improved gripping. The latter may be e.g. provided with incrustations, serrations, grooves, indentations or any other operation commonly known in the art.

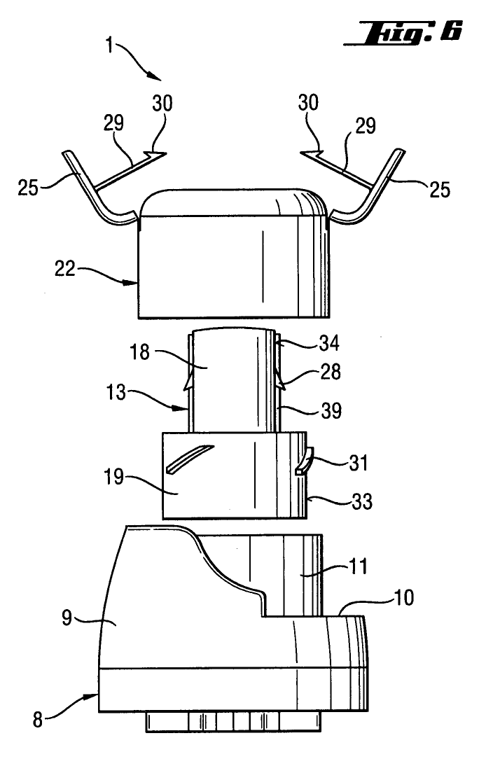

In an even more preferred execution of the present invention, said actuating means may be readily identifiable by the person skilled in the art provided that it is suited for performing the purported action. In a very preferred embodiment, said closing means are in the form of two separate trapping doors. Typically, said trapping doors are preferably pivotable through a suitable means of articulation which joins said closing means to said actuating means and which is typically designed so as to permit said closing means to pivot around a pre-determined axis. Suitable means of articulation for use herein will easily be recognized by those skilled in the art. According to a preferred embodiment of the present invention, the means of articulation is a hinge-type assembly which may be conventionally known hinges selected from the group of pivot-hinge, “butterfly-hinge” and “three-legged-hinge” also known as living hinge. One preferred execution is represented e.g. in FIG. 5.

In another highly preferred embodiment, said closing means is connected to said discharging means via a connecting means, the role of which being to render the motion of said closing means dependent upon the raising and lowering motion of discharging means. Said connecting means are preferably provided with a locking means adapted to inter-engage a corresponding clasping means located in said discharging means so as to maintain said closing means tightly linked to said discharging means. Accordingly, said connecting means may preferably be in the form of at least one flexible connecting arm, said locking means is preferably in the form of one or more hooks, and said clasping means is preferably in the form of one or more lugs.

The actuating means for use in the present invention may be formed from any suitable material commonly known in the art. Preferably, said actuating means is formed as a single piece from heat sealable thermoplastic materials such as polyethylene or polypropylene single piece. According to another preferred embodiment, said closing means is preferably formed from the same thermoplastic material as said actuating means.

### Primary Complementary Means of Raising and Lowering the Discharging Means

The dispensing closure according to the present invention further comprises, as another essential technical feature, primary complementary means of raising and lowering said discharging means.

Primary complementary means for use in the present invention are located in said discharging means and in said hollow sleeve, and are adapted to switch said discharging means from a lower position and an upper position. Suitable primary complementary means for use herein will easily be recognized by those skilled in the art.

According to a preferred embodiment of the present invention, said primary complementary means of raising and lowering said discharging means are performing their action by means of rotation, preferably by means of axial rotation. Suitable primary complementary means include but are not limited to, angled or helical threads, helical grooves or notches, in combination with complementary helical threads or helical threads or lugs.

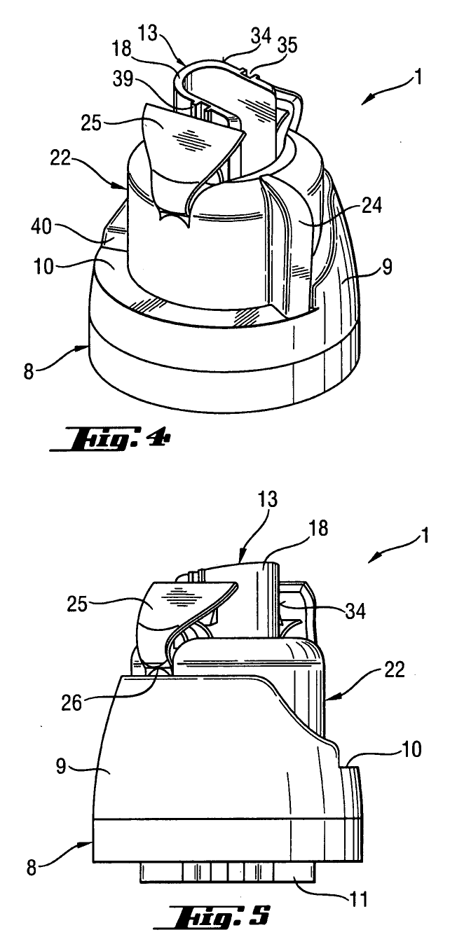

According to a preferred embodiment of the present invention, said primary complementary means of raising and lowering said discharging means, are a cooperative combination of discontinuous helical threads. In a more preferred execution, and as represented in FIG. 4 and FIG. 7, said helical threads are located in said discharging means, preferably in the outer surface of discharging means, more preferably in the outer surface of said spout barrel, and in the inner surface of said hollow sleeve.

As indicated above, the primary complementary means are adapted to switch said discharging means from a lower position and an upper position. In a preferred execution of the present invention, said primary complementary means are activated, i.e. allowed to perform the intended action, by rotating said actuating means onto the plan formed by said platform.

According to a highly preferred execution of the present invention, said primary complementary means are adapted so as to allow said discharging means to be switched from said lower position to said upper position through a limited angular displacement, preferably below 180 degrees, more preferably between 180 and 120 degrees, most preferably between 150 and 120 degrees. In a very preferred embodiment, said skirt is adapted such as angular displacement of more than 180 degrees is not permitted. By way of example, this may be achieved by means of suitable rotation stops, as represented in FIG. 2 and FIG. 4.

### Secondary Complementary Means of Raising and Lowering the Discharging Means

The dispensing closure according to the present invention further comprises, as another essential technical feature, secondary complementary means of raising and lowering said discharging means. Said secondary complementary means are adapted such as to work in cooperation with and actuate said primary complementary means so that for them to perform their action of raising and lowering said discharging means.

Secondary complementary means for use in the present invention are located in said actuating means and in said discharging means. Suitable secondary complementary means for use herein will easily be recognized by those skilled in the art.

According to a preferred embodiment of the present invention, said secondary complementary means of raising and lowering said discharging means are performing their action by means of a sliding motion, preferably by means of an axial sliding motion. Suitable secondary complementary means include but are not limited to, angled or vertical threads, angled or vertical grooves or notches, in combination with complementary angled or vertical threads, or lugs.

According to a preferred execution of the present invention, said secondary complementary means of raising and lowering said discharging means, are a cooperative combination of at least one continuous and longitudinal groove with at least one lug. In a more preferred execution, and as represented in FIG. 4 and FIG. 7, said at least one continuous groove is located in said discharging means, preferably in the outer surface of said discharging means, more preferably in the outer surface of said spout stem, and said at least one lug is preferably positioned in the inner surface of said actuating means.

According to this very preferred execution, when said actuating means is being engaged in a rotational movement, said at least one lug, located in the inner surface of said spout stem and housed within said at least one longitudinal groove, pushes towards the side-walls of said at least one longitudinal groove thereby causing said primary complementary means to perform their action of raising and lowering said discharging means. The pushing action of said at least one lug towards the side-walls of said at least one longitudinal groove in combination with said primary complementary means, allows transforming the rotational movement of said actuating means into an axial motion of said discharging means within said hollow sleeve favourized by an axial sliding motion of said at least one lug into said at least one groove.

Advantageously, said at least one longitudinal groove allows for better guiding of said discharging means while performing said raising and lowering motion within said hollow sleeve.

In the normal course of a closing/opening operation and according to a highly preferred embodiment of the present invention, while said discharging means is in its lower position (see FIG. 2 in combination with FIG. 9), the dispensing passage is obstructed by said obstructing member which therefore seals the content of the container. Also, while said discharging means is in its lower position, said closing means covers said opening which provides a further sealing means for the container content and provides a visual indication that the dispensing container according to the invention is in its closed position. Advantageously, accumulation of dried pourable material and dust is efficiently prevented when said closing means is covering said opening.

While said actuating means is being engaged in a rotational movement, said secondary complementary means actuate said primary complementary means thereby causing said discharging means to progressively raise towards the axis of said hollow sleeve. As the discharging means is raising, said closing means is progressively opened, pushed by the upper extremity of said discharging means. Concurrent to this raising motion, said dispensing passage is becoming progressively less and less obstructing vis-à-vis the content of said container. When said discharging means has attained its upper position, the discharging means is completely revealed to the user in an intriguing way, allowing the content of the container to be dispensed through the discharging means via said dispensing passage.

Once the desired amount of pourable material has been dispensed, said actuating means is to be engaged into a reverse rotational movement thereby causing said discharging means to progressively retract back into said hollow sleeve. Concurrent to this retraction motion, the clasping means of discharging means inter-engage with said locking means in such a way that said clasping means retracts said locking means back towards the direction of the container, thereby causing said closing means to integrally cover said opening back.

In the context of the present invention, it is preferred that said primary complementary means and said secondary complementary means are integrally part of the specific elements they are located in. More specifically and according to a highly preferred embodiment, said clasping means are preferably integrally part of said discharging means, said locking means are preferably integrally part of said closing means, said at least one continuous groove is preferably integrally part of said discharging means and said at least one lug is preferably integrally part of said actuating means.

### Container Closure Assembly

In another embodiment, the present invention is directed to a container closure assembly, comprising:
(a) a container having a body portion for holding the container content, a lower closed end for supporting the container, an upper end including a means of attachment thereon adapted to receive and affix a dispensing closure for containers;
(b) a dispensing closure according to the invention, mounted on the container.

### A Method of Dispensing the Content of a Container

The present invention further encompasses a method of dispensing the content of a container comprising the steps of:
(a) providing a container closure assembly as above-described wherein the discharging means is in its lower position;
(b) actuating the actuating means so as to raise the discharging means to its upper position;
(c) pouring the required amount of the container content through the dispensing passage;
(d) actuating the actuating means so as to lower the discharging means back towards its lower position.

### Use of a Container Closure Assembly According to the Invention, for Dispensing a Liquid Composition.

In a further embodiment, the present invention is directed to the use of a closure assembly according to the present invention for dispensing a liquid composition, preferably a liquid detergent composition, most preferably a liquid laundry detergent composition.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A dispensing closure suitable for being mounted on a container, said container having a dispensing opening and being suitable for containing a pourable product in its interior volume, wherein said dispensing closure comprises:
(a) a base member comprising a means for attachment to said container, a hollow sleeve defining a draining canal adapted to communicate with the interior volume of said container and wherein said hollow sleeve comprises an obstructing member;
(b) a discharging means adapted to communicate with said draining canal via a dispensing passage capable of dispensing said pourable product;
(c) an actuating means which under actuation is capable of actuating primary complementary means of raising and lowering said discharging means, wherein said primary complementary means are located in said discharging means and in said hollow sleeve, and are adapted to switch said discharging means from a lower position wherein said dispensing passage is sealingly obstructed by said obstructing member with respect to the content of said container, and an upper position wherein said dispensing is unobstructed; and wherein said primary complementary means are actuated by secondary complementary means of raising and lowering said discharging means which are located in said actuating means and in said discharging means.

2. A dispensing closure according to claim 1, wherein said base member is provided with a substantially circular shape, preferably a circular shape, when seen from the top.

3. A dispensing closure according to claim 1, wherein said means for attachment is a cooperative thread.

4. A dispensing closure according to claim 1, wherein said base member comprises a skirt and a platform.

5. A dispensing closure according to claim 1, wherein said hollow sleeve has a substantially cylindrical shape, preferably a cylindrical shape.

6. A dispensing closure according to claim 1, wherein said obstructing member has a substantially rounded, convex shape, preferably a rounded, convex shape with the convexity turned towards said discharging means.

7. A dispensing closure according to claim 1, wherein said discharging means is a pouring spout, preferably a beveled spout.

8. A dispensing closure according to claim 7, wherein said pouring spout comprises a spout stem and a spout barrel.

9. A dispensing closure according to claim 8, wherein said spout barrel has a substantially cylindrical shape, preferably a cylindrical shape.

10. A dispensing closure according to claim 1, wherein said actuating means is a turning cap, preferably having a substantially cylindrical shape, more preferably having a cylindrical shape.

11. A dispensing closure according to claim 4, wherein said actuating means extends upwardly from said platform and at least part thereof projects out from said skirt via a housing created into said skirt for that purpose.

12. A dispensing closure according to claim 10, wherein said actuating means is capable of rotatably rotating onto the plan formed by said platform and is preferably actuated by rotation thereof.

13. A dispensing closure according to claim 1, wherein said actuating means further comprises a gripping means.

14. A dispensing closure according to claim 10, wherein said actuating means further comprises an opening which is preferably centrally located vis-à-vis said actuating means.

15. A dispensing closure according to claim 14, wherein said actuating means is further provided with a closing means which is preferably in the form of two trapping doors which are pivotable around a pre-determined axis.

16. A dispensing closure according to claim 14, wherein said closing means is connected to said discharging means via a connecting means which is preferably provided with a locking means.

17. A dispensing closure according to claim 16, wherein said discharging means comprises a clasping means adapted to inter-engage said locking means

18. A dispensing closure according to claim 17, wherein said connecting means is at least one flexible arm, said clasping means is one or more lugs and said locking means is one or more hooks.

19. A dispensing closure according to claim 1, wherein said hollow sleeve is capable of engaging said discharging means for axial motion.

20. A dispensing closure according to claim 1, wherein said primary complementary means of raising and lowering said discharging means are performing their action by means of rotation, preferably by means of axial rotation.

21. A dispensing closure according to claim 20, wherein said primary complementary means are a cooperative combination of discontinuous helical threads.

22. A dispensing closure according to claim 8, wherein said primary complementary means are located in the outer surface of said spout barrel, and in the inner surface of said hollow sleeve.

23. A dispensing closure according to claim 1, wherein said primary complementary means are adapted so as to allow said discharging means to be switched from said lower position to said upper position through a limited angular displacement which is preferably below 180 degrees.

24. A dispensing closure according to claim 1, wherein said secondary complementary means of raising and lowering discharging means are performing their action by means of a sliding motion, preferably by means of an axial sliding motion.

25. A dispensing closure according to claim 22, wherein said secondary complementary means are a cooperative combination of at least one continuous groove with at least one lug.

26. A dispensing closure according to claim 25, wherein said at least one continuous groove is located in the outer surface said spout stem, and said at least one lug is located in the inner surface of said actuating means.

27. A dispensing closure according to claim 1, wherein said pourable product is liquid, preferably a viscous liquid.

28. A container closure assembly, comprising:
(a) a container having a body portion for holding container content, a lower closed end for supporting said container, an upper end including a means of attachment thereon adapted to receive and affix a dispensing closure for containers; and
(b) a dispensing closure according to any of the preceding claims mounted on said container.

29. A method of dispensing the content of a container comprising the steps of:
(a) providing a container closure assembly according to claim 28 wherein said discharging means is in its lower position;
(b) actuating said actuating means so as to raise said discharging means to its upper position;
(c) pouring the required amount of the container content through said dispensing passage;
(d) actuating said actuating means so as to lower said discharging means back towards its lower position.

30. Use of a dispensing closure according to claim 1 for dispensing a liquid laundry detergent composition.
